(19) United States
(12) Patent Application Publication
(10) Pub. No.: US 2014/0034621 A1
(43) Pub. Date: Feb. 6, 2014

(54) METHOD AND SYSTEM OF HOT WIRE JOINT DESIGN FOR OUT-OF-POSITION WELDING

(71) Applicant: LINCOLN GLOBAL, INC., City of Industry, CA (US)

(72) Inventors: Joseph A. DANIEL, Sagamore Hills, OH (US); Michael Whitehead, Strongsville, OH (US); Lisa M. Byall, Rocky River, OH (US)

(73) Assignee: LINCOLN GLOBAL, INC., City of Industry, CA (US)

(21) Appl. No.: 13/793,091

(22) Filed: Mar. 11, 2013

Related U.S. Application Data
(60) Provisional application No. 61/679,470, filed on Aug. 3, 2012.

(51) Int. Cl. B23K 26/24

(52) U.S. Cl. CPC B23K 26/24
USPC 219/121.64; 219/121.63

(57) ABSTRACT

A method and system is provided for welding, using a laser-hot-wire welding system, in an out-of-position state, where the weld joint has a narrow groove opening but the groove of the weld joint has a wider portion than that between the workpiece surfaces than at the groove opening through which the welding operation is directed.

### PRIORITY

The present application claims priority to U.S. Provisional Patent Application No. 61/679,470 filed Aug. 3, 2012, which is incorporated herein by reference in its entirety.

### TECHNICAL FIELD

This invention relates to systems and methods for hot wire processing. More specifically, the subject invention relates to methods and systems for joint design that in one embodiment can be used in an out of position hot wire weld joint.

### BACKGROUND

In a laser hot wire or filler wire process between a wire and workpiece, a laser heats and melts a workpiece to form a molten puddle. A filler wire is advanced towards the workpiece and the molten puddle. The wire is heated by a separate energy source such that the wire approaches or reaches its melting point and contacts the molten puddle. The heated wire is fed into the molten puddle for carrying out the hot wire process. Accordingly, transfer of the filler wire to the workpiece occurs by simply melting the filler wire into the molten puddle. The term “hot wire process” is used herein in a broad manner and may refer to any applications including overlaying, welding or joining. Overlaying processes may include: brazing, cladding, building up, filling, and hard-facing. For example, in a “brazing” application, a filler metal is distributed between closely fitting surfaces of a joint via capillary action. Whereas, in a “braze welding” application the filler metal is made to flow into a gap. Much of the discussion below will reference “welding applications. This terminology is used for clarity and brevity, and it is understood that embodiments of the present invention are not limited to welding/joining applications but also includes overlaying applications.

Respectively shown in FIGS. 1A and 1B are single and double butt welds formed in known groove joint formations. Generally, a groove joint tapers narrowly from, for example, the upper surface of the workpiece to a depth between the upper and lower surface. For a double groove, as seen in FIG. 1B, the groove tapers narrowly from each surface of the workpiece(s) being joined. Known welding grooves and joints include, V-grooves and U-grooves. Moreover, hot wire processes have been used to join grooves in which a high intensity energy source is directed and filler wire acts in a proximal-to-distal direction (upper-to-lower surface direction). Due to the taper of the groove, the angle at which the energy beam is delivered and/or the angle at which the filler wire is delivered does not vary or its variability is minimized when welding from one abutting surface to the other over the groove and the groove angle defined by the abutting surfaces. For double grooves as shown in FIG. 1B, the workpiece(s) are manipulated, such as for example, by turning the workpieces over so that the energy beam and filler wire can be delivered in the proximal-to-distal direction.

Further limitations and disadvantages of conventional, traditional, and proposed approaches will become apparent to one of skill in the art through comparison of such approaches with embodiments of the present invention as set forth in the remainder of the present application with reference to the drawings.

### SUMMARY

Embodiments of the present invention provide for a groove design for use in a hot wire process. More specifically, one embodiment provides for a groove defined by a first workpiece having a first, upper surface and a second lower surface opposite the upper surface. Extending between the upper and lower surfaces is an abutting edge surface. The embodiment includes a second workpiece abutting the first workpiece. The second workpiece includes a first upper surface and a second lower surface opposite the upper surface with an abutting edge surface extending between the upper and lower surfaces of the second workpiece. The abutting surface of the second workpiece opposes the abutting surface of the first workpiece to define a welding groove therebetween. In one embodiment, the welding groove defines a first width defined by the abutting surfaces of the workpiece at at least one of the upper and lower surfaces of the workpieces. Between the upper and lower surfaces of the workpieces, the welding groove defines a second width greater than the first width such that the groove tapers narrowly in the distal-to-proximal direction going from the lower surface to the upper surface so as to define an inverted welding groove. In one embodiment, the inverted welding groove defines a single groove. In another embodiment, the inverted welding groove defines a double groove.

Another embodiment of the invention provides for a hot wire process to weld one of a single or double inverted welding groove. In one particular embodiment, a laser beam and filler wire are delivered to the joint. The beam and laser are moved from abutting surface to abutting surface of the workpieces to form the weld joint. In one aspect, at least one of the power to the laser source of the laser beam or the heating signal applied to the filler wire is controlled to form the hot wire weld. In another aspect, the hot wire process is controlled to provide for an out-of-position hot wire process weld. In one particular embodiment of the hot wire process, a supporting member engages the lower surfaces of the workpieces and moves in coordination with the laser beam and filler wire. The supporting member provides out-of position access to a welding groove for a laser beam and filler wire directed in a distal-to-proximal direction. In one particular embodiment, the supporting member is a substantially planar member with an aperture through which the laser beam and filler wire extends to access the welding groove defined by the workpieces.

These and other features of the claimed invention, as well as details of illustrated embodiments thereof, will be more fully understood from the following description and drawings.

### BRIEF DESCRIPTION OF THE DRAWINGS

The above and/or other aspects of the invention will be more apparent by describing in detail exemplary embodiments of the invention with reference to the accompanying drawings, in which:

FIGS. 1A and 1B are known groove butt welds;

FIG. 2A is an illustrative schematic embodiment of a hot wire process system;

FIGS. 2B-2D are detailed views of the system of FIG. 2A in hot wire process to join an exemplary groove between two workpieces;

FIG. 3A is an illustrative embodiment of the single groove joined in FIGS. 2B-2C;

FIG. 3B is an illustrative embodiment of a double groove that can be made with the system in FIG. 2A;

FIG. 4 is an illustrative embodiment of a hot wire weld joint of the groove of FIG. 3A using the system of FIG. 2A.

FIG. 5A is a detailed view of one embodiment of an out-of-position hot wire process using the system of FIG. 2A.

FIG. 5B is an illustrative embodiment of a hot wire weld joint formed by the process of FIG. 5A;

FIG. 5C is a detailed view of another embodiment of an out-of-position hot wire process using the system of FIG. 2A;

FIG. 6 is a detailed view of another embodiment of an out-of-position hot wire process using the system of FIG. 2A.

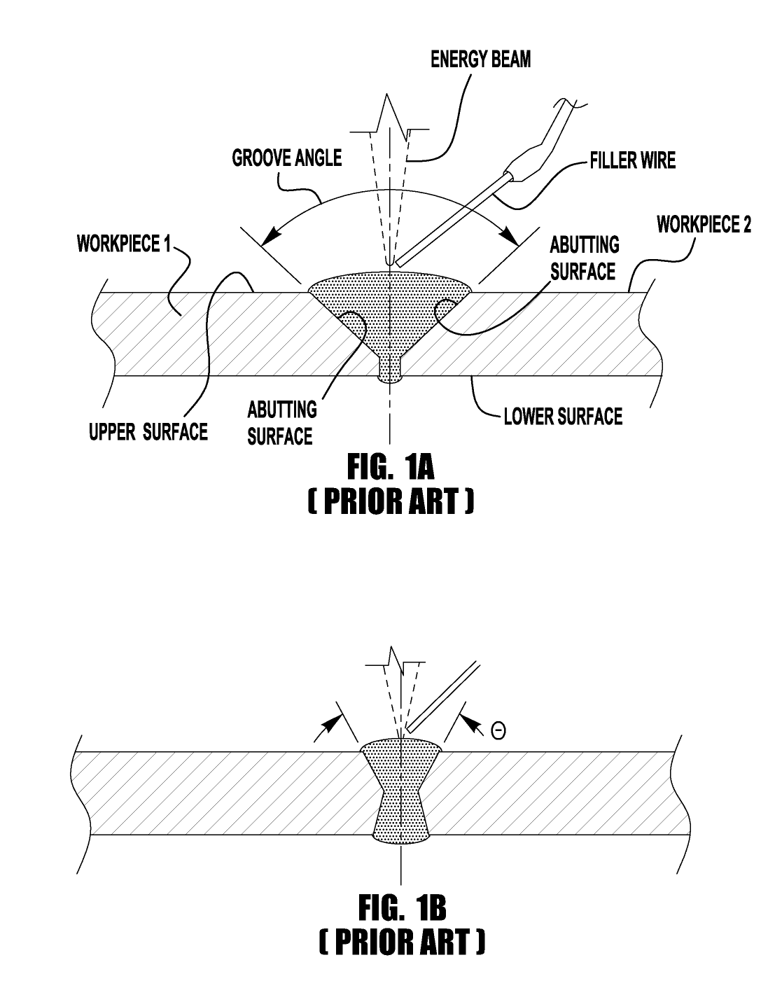

### DETAILED DESCRIPTION

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

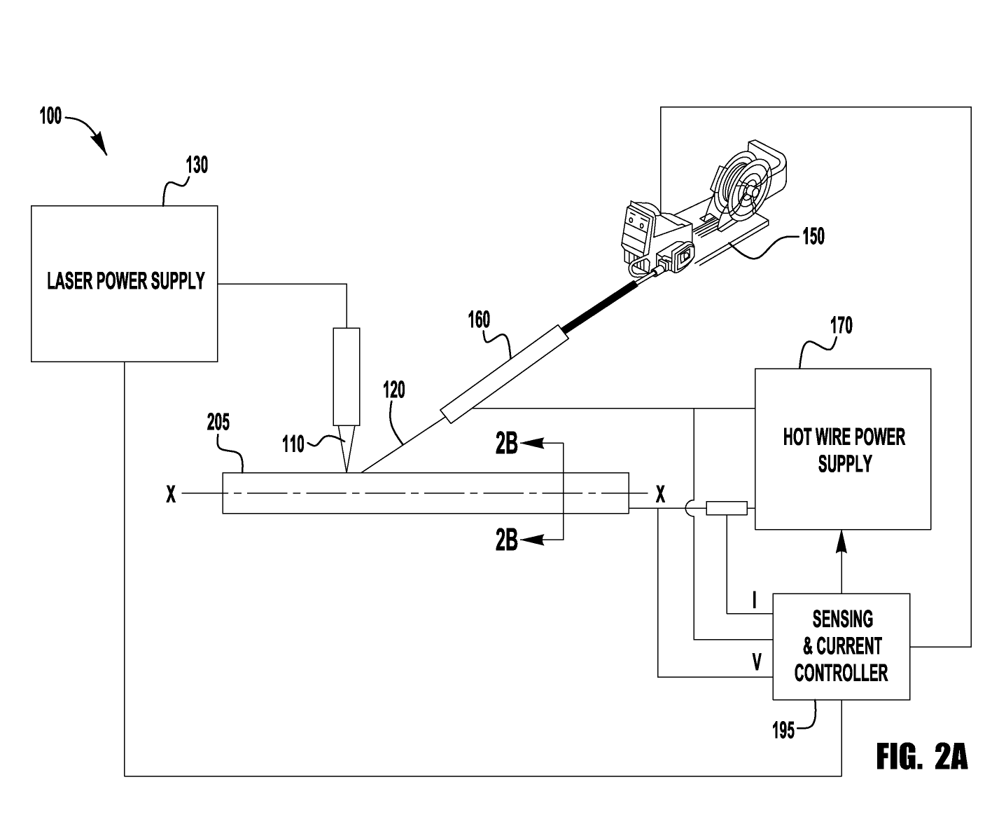

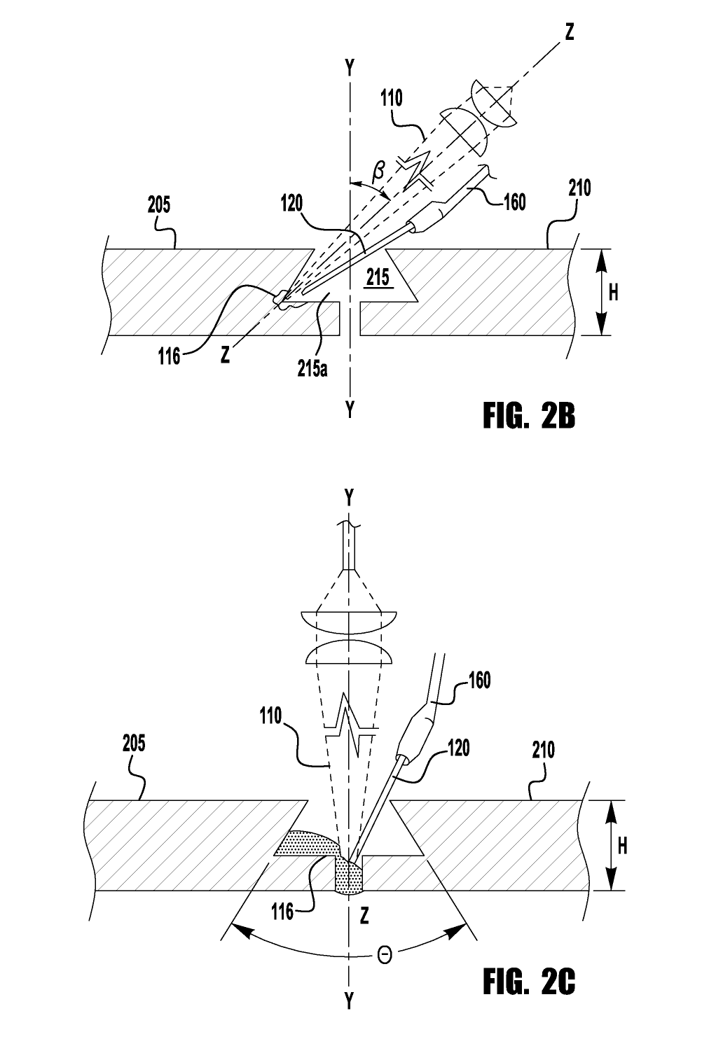

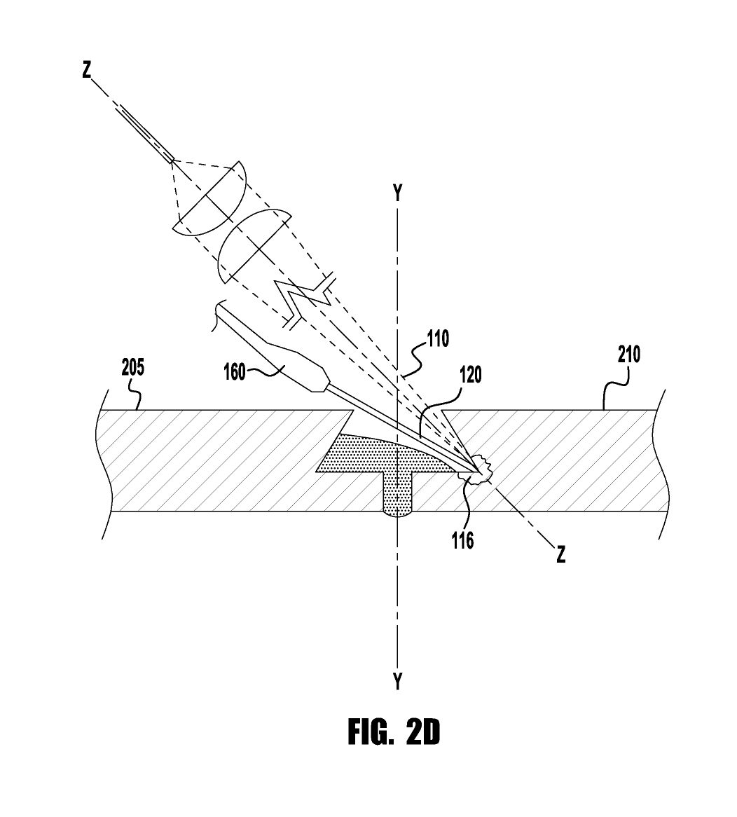

Shown in FIGS. 2A and 2B is a representative system 100 for performing a weld or joining operation using a hot wire process to join a first workpiece 205 to a second workpiece 210. The system shown is using a laser as a heat source, but embodiments are not limited to the use of a laser and other high energy heat sources can be used, consistent with the descriptions in U.S. Patent Publication No. 2011/0297658. Further details of the system 100 are shown and described in U.S. Patent Publication No. 2011/0297658 which is incorporated by reference herein in its entirety and attached as Exhibit A. For purposes of clarity, the embodiment discussed below with reference a laser as the heat source, but other embodiments can employ a different heat source. As shown in FIG. 2A, the workpieces 205, 210 (see FIG. 2B) and a laser beam 110 and filler wire 120 are translated relative to one another along a joint axis X-X.

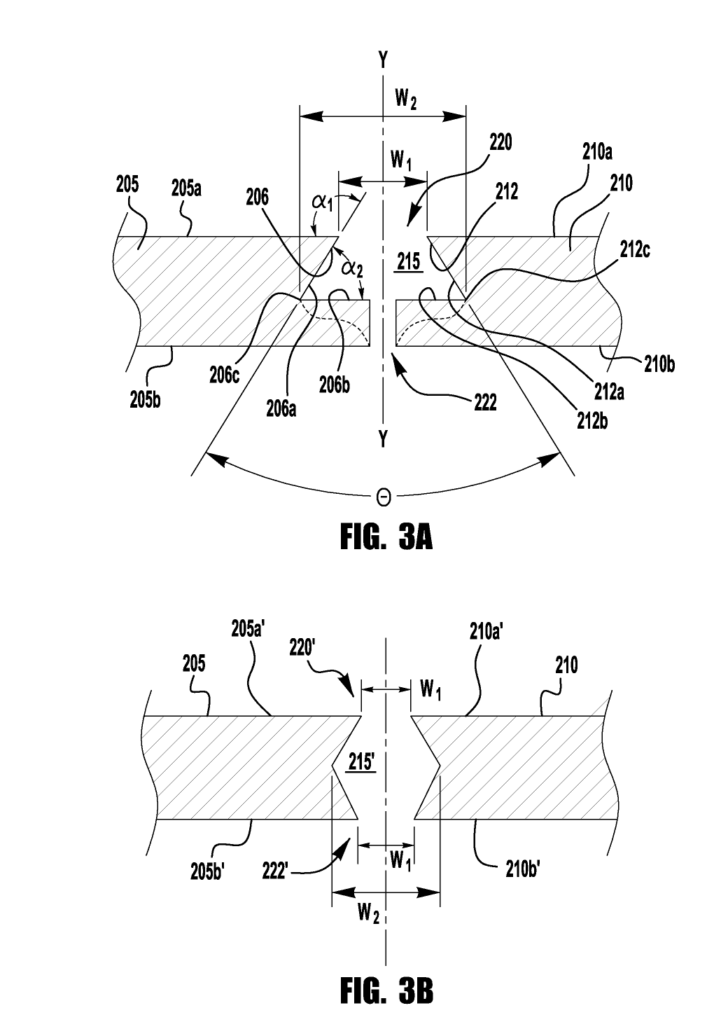

Generally, the subject joining processes described herein provide for single and double groove weld joints in which the groove between workpieces widens as it gets deeper, relative to the welding/cladding surface. For example, shown in FIG. 3A is one embodiment of a subject single groove 215 between a first workpiece 205 and a second workpiece 210 abutting one another for forming an exemplary butt weld. The subject groove 215 extends from the first or upper surface 205a, 210a of the first and second workpieces 205, 210 to the second or lower surfaces 205b, 210b of the workpieces to define a longitudinal groove axis Y-Y. It is the upper surfaces 205a and 210a which are the welding/cladding surfaces at which the laser and hot wire are directed during the process. Accordingly, the subject groove 215 has a proximal end 220 defining a first width W1 by adjacent upper surfaces 205a, 210a of the workpieces. The subject groove 215 has a distal end 222 defined by adjacent lower surfaces 205b, 210b of the workpieces. The groove 215 is formed in one embodiment to define a second groove width W2, between the proximal and distal ends 220, 222 of the groove 215 with the second width W2 being greater than the first width W1.

The groove 215 is further defined by the geometry of abutting and opposed surfaces 206, 212 of the first and second workpieces 205, 210. In one aspect, the abutting surfaces 206, 212 may be symmetrical about the groove axis Y-Y as shown. Alternatively, the abutting surfaces 206, 212 may be asymmetrical about the groove axis Y-Y. With specific reference to abutting surface 206 of the first workpiece 205, the surface 206 has a first portion 206a and a second portion 206b. The first portion of the surface 206a, defines an inverted bevel angle or more particularly, an obtuse angle α1 with respect to upper surface 205a. For a symmetric groove 215, the first portion 212a of the abutting surface 212 of the second workpiece 210, defines an inverted bevel angle that mirrors that of the first workpiece 205. The opposed first portions 206a, 212a of the abutting surfaces 206, 212 define an inverted groove angle θ.

As shown, the second portion 206b of the abutting surface 206 includes a portion that intersects the first portion surface 206a to define an acute angle α2 and extends perpendicular to the groove axis Y-Y. For the workpieces 205, 210 shown, the intersections of the first portions 206a, 212a and second portions 206b, 212b define spaced apart vertices 206c, 212c defining the second width W2. Alternatively, the second surface portion 206b can include one or more curved surfaces, for example as shown in dashed line, to define a root face, groove radius and a root opening at the distal end 222 of the groove 215. Accordingly, the second portion surfaces 206b, 212b can be variably configured with variable first portion surfaces 206a, 212a to provide the first groove width W1 and a greater second groove width W2 to define other types of “inverted” grooves. Moreover, the abutting surfaces 206, 212 may be configured for forming a double inverted groove as shown for example in FIG. 3B. Accordingly to the extent the double inverted groove is welded in the orientation shown in FIG. 3B, from both the upper surfaces 205a′, 210a′ and the opposite lower surfaces 205b′, 210b′, the inverted groove joint may be welded from the lower surfaces 205b′, 210b′ using an out-of-position hot wire process described in greater detail below.

With reference to FIGS. 2B, 2C and 2D, the inverted groove 215 is welded in an exemplary hot wire process. The laser beam is directed to the abutting surfaces 206, 212 to form and maintain a molten puddle 116. A filler wire extends from a contact tube 160 and fed from a wire feeder 150, as seen in FIG. 2A, into the groove 215. The filler wire 120 is disposed relative to the laser beam 110 so as to lead, lag, or intersect the laser beam 110 for hot wire transfer of filler material to the molten puddle 116. In one aspect, the workpieces 205, 210 are axially translated relative to the laser beam and filler wire 120 so as to affect the lead or lag of the filler wire 120 to the laser beam 110. Alternatively, the filler wire 120 and laser beam 110 are moved linearly along the joint axis X-X.

To complete the weld joint, the laser beam 110 is moved over the abutting surfaces 206, 212 to generate and locate the molten puddle 116 for transfer of filler material to the puddle. Accordingly, in one aspect, the laser beam 110 and filler wire 120 is rotated back and forth over the groove angle θ from workpiece to workpiece to fill the groove 215 with a weld metal and form the weld joint. The weld metal in one embodiment is a solidified mixture of the filler material and base material from each of the workpieces 205, 210. The subject hot wire process alters the angle of the laser beam axis Z-Z relative to the groove axis Y-Y to define the beam angle β. Moreover as the joint fills with weld metal the depth at which the laser beam acts varies over the weld depth H which may be equal to or less than the thickness of the workpieces 205, 210.

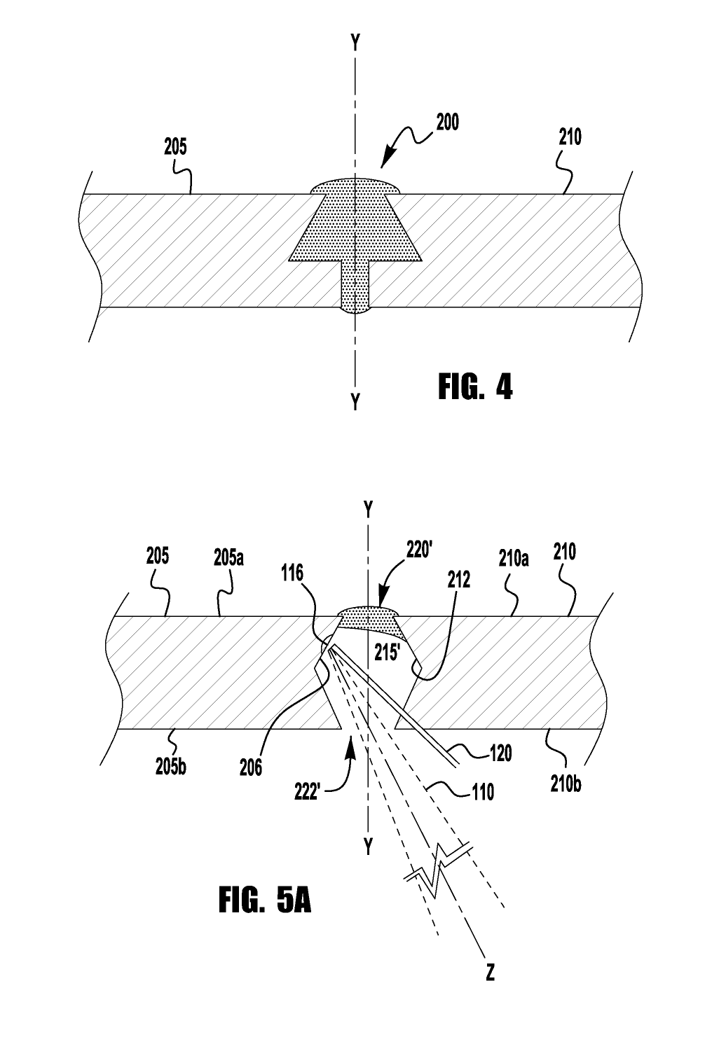

In one aspect of the system 100 of FIG. 2, the controller 195 is configured to control the laser beam 110, filler wire feed and/or the heating of filler wire 120. In one aspect, the controller alters the depth at which the laser acts as a function of its beam angular axis β. The subject process produces the hot wire weld joint 200 of FIG. 4. This joint configuration can be advantageous in a number of applications, including when welding out-of-position. For example, if the upper surfaces 205a and 210a are in a vertical position or an upside down position (as compared to what is shown in the figures) the exposed surface of the puddle is relatively small. As such, the puddle can be more stable than a larger puddle in out-of-position welding situations.

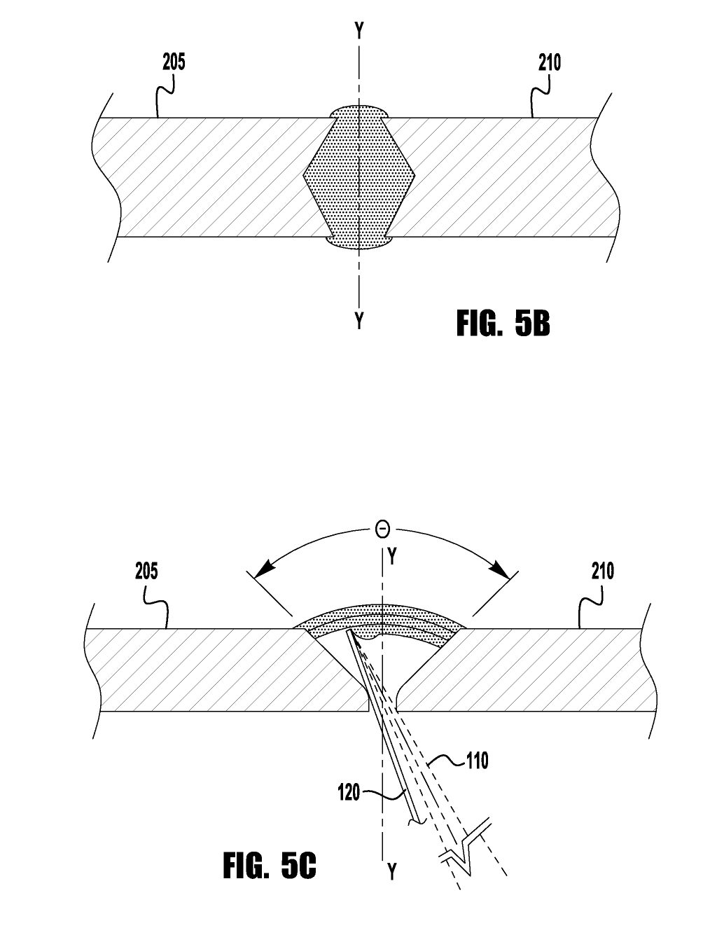

Similar to that discussed above, the subject hot wire process of FIG. 3B can be carried in an out-of-position configuration. With reference to FIG. 5A, the laser beam 110 is delivered in the distal-to-proximal direction from the distal opening 222′ of the joint 215′ to generate and maintain a molten puddle 116 along the surfaces 206, 212 of the proximal portion of the groove 215′. The filler wire 120 is also fed in the distal-to- proximal direction and heated to transfer filler wire into the molten puddle. It is noted that the wire 120 is shown off-line with respect to the laser beam 110 for purposes of clarity so that each can be depicted. However, in some exemplary embodiments the beam 110 and the wire 120 are in-line—in a travel direction. The hot wire progresses from abutting surface 206 to abutting surface 212 to form the weld metal in a proximal- to-distal direction resulting in the inverted double weld joint of FIG. 5B. Thus, as shown the resultant weld joint has upper and lower surface openings which are not as wide as the maximum width of the weld joint. Again, such a joint configuration can be used in any number of welding applications, including but not limited to out-of-position welding. Because an out-of-position hot wire process can be carried out, with a typical or known groove, such as for example a typical V-groove, can be welded in an out-of-position hot wire process as seen, for example, in FIG. 5C.

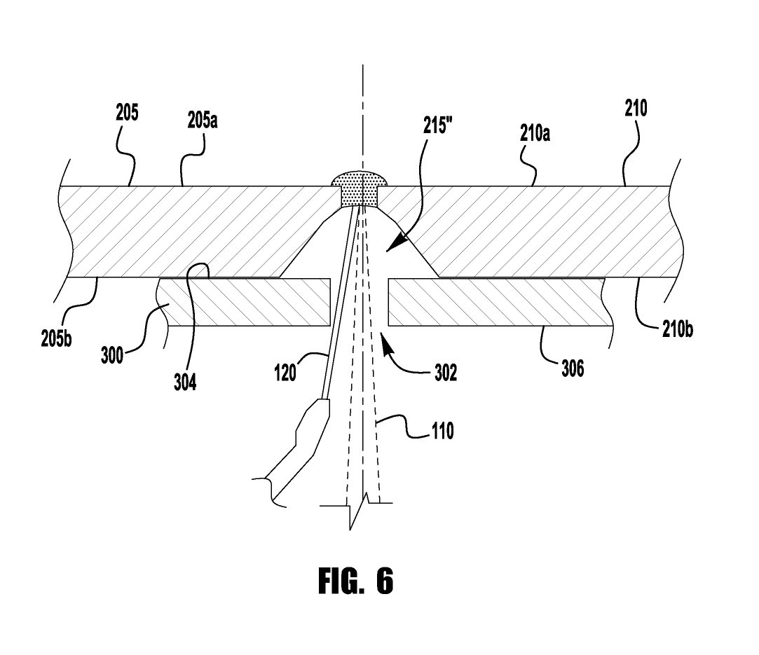

Shown in FIG. 6 is another exemplary embodiment of an out-of-position hot wire process. Shown is an inverted groove 215″ (or an upside down generally V- groove) with the laser beam 110 and filler wire 120 delivered to the joint in a distal-to-proximal direction. Engaged with the lower surfaces 205b, 210b of the workpieces 205, 210 is a slide member 300. A slide member 300 includes an aperture 302 through which the laser beam 110 and filler wire 120 is delivered to the groove 215″. The slide member 300 may be, for example, a plate member 300 having an upper surface 304 and a lower surface 306 with the aperture 302 extending therethrough. In one particular embodiment, the upper surface 304 of the plate member 300 engages the lower surfaces of the workpieces 205, 210 and slides over the workpieces in coordination with the movement of the laser beam 110 and filler wire 120 to provide aperture access to the groove 215 and support weld metal formation against the force of gravity. Thus, during out-of-position welding the plate member 300 provides a biasing force against the molten puddle to help the puddle stay in position. The aperture 302 is of a size and shape to allow the beam 110 and the wire 120 to pass through with sufficient clearance, and in fact can be two separate openings for the beam 110 and wire 120, respectively. The plate 300 can be made of any heat resistance material, including, but not limited to, ceramic materials. The material should be chosen such that it does not melt during the process. Moreover, in some exemplary embodiments a small impression or cavity can be formed in the plate 300 adjacent to the weld joint 215″. In such embodiments, the cavity or depression allows the weld metal to protrude above the surfaces 205b/210b by some amount, but still provides a biasing force against further distortion of the bead. Such cavity can also prevent excessive interference between the plate and the puddle during welding so that the plate does not drag or interfere with the weld puddle formation. In exemplary embodiments, the plate can be secured to at least the contact tube 160 such that they move in unison during the welding/overlaying operation. It is noted that the plate 300 can be used with any weld joint configuration, and is not limited to the configuration shown in FIG. 6, which is intended to be exemplary.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed.

What is claimed is:

1. A method of forming a groove weld joint between a first abutting wall of a first workpiece and a second abutting wall of a second workpiece, the first and second abutting walls being opposed one another to define a groove axis therebetween, the method comprising:
applying a beam of heat from a first heat source through a groove opening between and defined by each of the first and second abutting walls to form a molten puddle between the first and second abutting walls, the beam axis defining an obtuse angle with respect to the groove axis;
transferring a filler material to the molten puddle from a wire heated by a second heat source, where said filler material is also passed through the groove opening; and
varying the obtuse angle between the beam axis and the groove axis,
wherein a maximum width of the groove weld joint between each of the first and second abutting walls is wider than a maximum width of said groove opening.

2. The method of claim 1, wherein the varying includes progressing from the first abutting wall to the second abutting wall.

3. The method of claim 1, wherein the groove weld joint has a second groove opening opposite of the groove opening, and wherein a maximum width of said second groove opening is less than said maximum width of said groove weld joint.

4. The method of claim 1, wherein the groove weld joint has a second groove opening opposite of the groove opening, and wherein a maximum width of said second groove opening is less than said maximum width of said groove opening.

5. The method of claim 1, wherein at least one of said first and second abutting walls comprises at least a first and second wall portion, said first wall portion having a first angle with respect to said groove axis and said second wall portion having a second angle with respect to said groove axis that is different from said first angle.

6. The method of claim 1, wherein both of said first and second abutting walls comprises at least a first and second wall portion, respectively, and where said first wall portion of each of said first and second abutting walls has a first angle with respect to said groove axis and said second wall portion of each of said first and second abutting walls has a second angle with respect to said groove axis that is different from said first angle.

7. The method of claim 1, wherein at least one of said first and second abutting wall comprises at least a first and second wall portion, said first wall portion being parallel to said groove axis and said second wall portion having a first angle with respect to said groove axis.

8. A welding system to form a groove weld joint between a first abutting wall of a first workpiece and a second abutting wall of a second workpiece, the first and second abutting walls being opposed one another to define a groove axis therebetween, the system comprising:
a laser beam device which emits a beam of heat from a first heat source through a groove opening between and defined by each of the first and second abutting walls to form a molten puddle between the first and second abutting walls, the beam axis defining an obtuse angle with respect to the groove axis;
a wire feeder system which directs a filler material to the molten puddle and directs said filler material through said groove opening;
a wire heating power supply which heats said filler material prior to said filler material entering said molten puddle; and
wherein a maximum width of the groove weld joint between each of the first and second abutting walls is wider than a maximum width of said groove opening.

9. The system of claim 8, wherein the groove weld joint has a second groove opening opposite of the groove opening, and wherein a maximum width of said second groove opening is less than said maximum width of said groove weld joint.

10. The system of claim 8, wherein the groove weld joint has a second groove opening opposite of the groove opening, and wherein a maximum width of said second groove opening is less than said maximum width of said groove opening.

11. The system of claim 8, wherein at least one of said first and second abutting walls comprises at least a first and second wall portion, said first wall portion having a first angle with respect to said groove axis and said second wall portion having a second angle with respect to said groove axis that is different from said first angle.

12. The system of claim 8, wherein both of said first and second abutting walls comprises at least a first and second wall portion, respectively, and where said first wall portion of each of said first and second abutting walls has a first angle with respect to said groove axis and said second wall portion of each of said first and second abutting walls has a second angle with respect to said groove axis that is different from said first angle.

13. The system of claim 8, wherein at least one of said first and second abutting wall comprises at least a first and second wall portion, said first wall portion being parallel to said groove axis and said second wall portion having a first angle with respect to said groove axis.
